(19) United States
(12) Patent Application Publication
(10) Pub. No.: US 2004/0117774 A1
(43) Pub. Date: Jun. 17, 2004

(54) Linguistic dictionary and method for production thereof

(75) Inventors: Nikolay Glushnev, Pointe Claire (CA); Brian O'Donovan, Castleknock (IE); Alexandre Troussov, Donabate (IE)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/619,070

(22) Filed: Jul. 14, 2003

(30) Foreign Application Priority Data
Dec. 12, 2002 (GB) 0228942.9

(51) Int. Cl. G06F 9/45

(52) U.S. Cl. 717/136; 717/110; 717/122

(57) ABSTRACT

A method and arrangement for handling case and other orthographic variations in linguistic databases by explicit representation comprising: explicit storage of all orthographic and case variations of words in the dictionary, and use of extended cut and paste codes to control dictionary size explosion and to make the restoration of the lemma more efficient. This provides the advantage of allowing very efficient handling of case and orthographic variants while performing a dictionary lookup.

### BACKGROUND OF THE INVENTION

1. Technical Field

This invention relates to electronic dictionaries and particularly to dictionaries represented as Finite State Transducers (FSTs).

2. Background Art

The IBM Dictionary and Linguistic Toolkit commonly known as LANGUAGEWARE supports over 30 different languages. All of these languages have their own orthography rules specifying the various ways that words can be written. Heretofore, versions of this dictionary toolkit had these orthographic rules for each language implicitly contained in the executable code (e.g., for searching the dictionary).

Most languages allow orthographic variation with regard to how words can be written. For example, English has a relatively straight forward rule for case variation such that a word which is represented in a dictionary in lower case should be treated as valid if it is written in all capitals or with a leading capital (e.g., the dictionary entry “book” could occur in a written text as “BOOK” or “Book” but not “bOOk”). This rule is fairly straight forward, but even in the case of English, there are some subtle variations in the orthographic rules dealing with accented characters. English normally only uses accented characters for loan words that came from other languages. In general, it is considered acceptable to replace any accented character with its unaccented equivalent (e.g., the dictionary entry “café” should be matched when the input is “café,” “cafe,” “Cafe,” “Café,” “CAFE,” or “CAFÉ”). Even for such simple rules, the need to search for matches in all orthographic variants slows down processing because each variant of the characters has a different encoding in a character encoding scheme such as Unicode (more details of which can be found at the website http://www.unicode.org).

The rules become even more complex in some other languages and sometimes even vary from location to location, e.g.:

1. In German, it is common to write the sharp-S character ‘β’ as ‘SS’ in the upper case versions of words so that the word “Straβe” becomes “STRASSE” in upper case. There is some debate about whether or not this convention is correct, so we would need to be able to recognize the uppercase version of the word written as “STRASSE” or “STRAβE.” Since this rule changes the number of characters in the word, we can no longer process word matches on a character by character basis.

2. In Germany, the o-umlaut character ‘ö’ is replaced by the character sequence “oe” when the writer is using a keyboard without the appropriate key. However, in English speaking countries, it is common to replace ‘ö’ with ‘o.’ Therefore, when consulting the German dictionary, we should match “Böblingen” with “Boeblingen” but not with “Boblingen.” However, when consulting the English dictionary, we should match “Böblingen” with “Boblingen” and “Boeblingen” as an alternate spelling.

3. In France, the accented characters lose their accents when written in uppercase (this rule is not followed by French speakers/writers in Canada). Therefore, when consulting a French dictionary we should match the character “E” in the input with any of the characters ‘E,’ ‘e,’ ‘é,’ ‘è,’ or ‘ê’ in the dictionary.

4. The computerized representation of characters typically allows for precomposed and decomposed forms (e.g., the character i-circumflex ‘î’ can either be represented precomposed as one unicode character, i.e., 0xEE, or decomposed as two unicode characters: i.e., 0x69 for the lower-case i and 0x5E for the circumflex \hat{ }). Computerized tools would typically need to incur a significant processing overhead to recognize that these two representations are equivalent. As a result, very few programs actually treat them as identical even though they should.

5. Many languages (e.g., Hebrew, Arabic, Korean, Chinese or Japanese) do not have the concept of lower-case and uppercase characters. Therefore, it is a waste of processing time to invoke case conversion routines when processing these languages.

Typically, existing dictionary look-up tools encode these rules in the run-time module. For example, products such as Summer Institute of Linguistics' PC-KIMMO (more details of which are available at the website http://www.sil.org/pckimmo), Inxight Software's INXIGHT (more details of which are available at the website http://www.inxight.com), and INTEX (more details of which are available at the website http://www.nyu.edu/pages/linguistics/intex) solve this problem by having an alphabet configuration file associated with each language dictionary. This approach works for most languages, but is computationally expensive. As a result, this approach compromises speed of dictionary look-up.

In addition, the alphabet configuration file approach is not completely flexible in terms of the type of orthographic rules that it can represent. In particular, this approach is not suitable for dictionaries containing multiple languages with different orthographic rules.

A different approach to dealing with orthographic variation is known from U.S. Pat. No. 5,995,922, which can reduce the dictionary size, but only by increasing the dictionary access time.

A need therefore exists for handling case and other orthographic variations in electronic dictionaries wherein the abovementioned disadvantage(s) may be alleviated.

### SUMMARY OF THE INVENTION

The present invention is based on explicitly storing the various legal orthographic variants in the dictionary, and as a result, significantly simplifying and speeding the run time code. This explicit storing of orthographic variants gives a significant competitive advantage over other electronic dictionary tools.

Further, the invention provides a new type of gloss format that limits dictionary size explosion and makes restoration of the citation or lemma form more efficient.

Unlike most existing dictionary look-up tools that encode rules of orthographic variation in the run-time module, the present invention allows a program to be run at dictionary build time to explicitly list all of the acceptable orthographic variants in the dictionary. Because this processing is done in advance of dictionary look-up, the dictionary look-up code no longer needs to have any code to understand the equivalences between different characters. Rather, the dictionary look-up code can do simple binary matches on character codes. Since the speed of the dictionary build is not as critical as the speed of dictionary look-up, it is better to put the processing at the build stage. Also, different orthographic rules can be used for building different dictionaries. This approach is much easier to maintain than having all the various orthographic rules built into the run time code, which needs to be able to simultaneously deal with several languages.

Tests have shown that it is possible to achieve a 45% speed increase for dictionary look-up by eliminating the need to look for handling case variations. However, this does come with a penalty of increasing the dictionary size to perhaps double the size of the original dictionary. Still, for most current applications, this is a more than acceptable trade-off.

In accordance with a first aspect of the invention, there is provided a method of producing a linguistic dictionary, the method comprising: storing explicitly substantially all orthographic variations of words in a finite state transducer database, and storing, for each of the orthographic variations, a cut and paste code extended by a gloss code that indicates whether at least part of the orthographic variation should be converted between upper and lower case.

In accordance with a second aspect of the invention, there is provided a linguistic dictionary comprising: a finite state transducer database for storing explicitly substantially all orthographic variations of words, wherein the database further stores, for each of the orthographic variations, a cut and paste code extended by a gloss code that indicates whether at least part of the orthographic variation should be converted between upper and lower case.

In accordance with a third aspect of the invention, there is provided a computer program product comprising computer program means for performing substantially the steps of: storing explicitly substantially all orthographic variations of words in a finite state transducer database, and storing, for each of the orthographic variations, a cut and paste code extended by a gloss code that indicates whether at least part of the orthographic variation should be converted between upper and lower case.

### BRIEF DESCRIPTION OF THE DRAWING

One method and arrangement for handling case and other orthographic variations in linguistic databases by explicit representation incorporating the present invention will now be described, by way of example only, with reference to the accompanying drawing, in which:

FIG. 1 shows a flow chart diagram depicting construction of a finite state transition dictionary incorporating the present invention.

### DETAILED DESCRIPTION OF THE INVENTION

The dictionaries referred to in the following description are typically used for morphological analysis. When a match is found for a surface form of a word, the gloss retrieved from the dictionary should indicate the lemma form of the word, the part of speech and some grammatical information. For example, if the surface word “talked” is matched by the dictionary, the gloss retrieved should indicate that this is a verb in the past tense with a lemma form of “talk.” To examine how this impacts upon the explicit representation of case variation in a dictionary, consider a simple dictionary containing the following forms:

| Word form | Lemma | Gloss |
|---|---|---|
| talking | talk | verb, present tense |
| talked | talk | verb, past tense |
| walking | walk | verb, present tense |
| walked | walk | verb, past tense |

A Finite State Transducer (FST) that will recognize these forms is given below:

| State | Transitions | Final | Gloss |
|---|---|---|---|
| 0 | w1, t10 | n | — |
| 1 | a2 | n | — |
| 2 | l3 | n | — |
| 3 | k4 | n | — |
| 4 | i5, e8 | n | — |
| 5 | n6 | n | — |
| 6 | g7 | n | — |
| 7 | | y | “walk”, verb, present tense |
| 8 | d9 | n | — |
| 9 | | y | “walk”, verb, past tense |
| 10 | a11 | n | — |
| 11 | l2 | n | — |
| 12 | k13 | n | — |
| 13 | i14, e17 | n | — |
| 14 | n15 | n | — |
| 15 | g16 | n | — |
| 16 | | y | “talk”, verb, present tense |
| 17 | d18 | n | — |
| 18 | | y | “talk”, verb, past tense |

Most dictionaries aim to minimize the number of states. It can be easily seen that in the above FST, states 1 through 9 share a similar structure to states 10 through 18. It is desirable to collapse these into a single set of states that would be shared by matches of variants of either the word “walk” or forms of the word “talk.” Unfortunately, this is not possible because of the fact that the glosses at the final states are not identical.

There is a well known method to get around this problem. It is called the “cut & paste” method for representing glosses. The idea behind this method is to replace the explicit representation of the lemma form with a notation indicating how many characters should be “cut” from the end of the surface form, followed by the characters (if any) which need to be pasted on to produce the lemma.

Using this method, the simple FST becomes transformed into the following form.

| State | Transitions | Final | Gloss |
|---|---|---|---|
| 0 | w1, t10 | n | — |
| 1 | a2 | n | — |
| 2 | l3 | n | — |
| 3 | k4 | n | — |
| 4 | i5, e8 | n | — |
| 5 | n6 | n | — |
| 6 | g7 | n | — |
| 7 | | y | “3”, verb, present tense (i.e., cut 3 characters |
| | | | from the end of “walking” to get |
| | | | the lemma “walk”) |
| 8 | d9 | n | — |
| 9 | | y | “2”, verb, past tense (i.e., cut 2 characters |
| | | | from the end of “walked” to get |
| | | | the lemma “walk”) |
| 10 | a11 | n | — |
| 11 | l12 | n | — |
| 12 | k13 | n | — |
| 13 | i14, e17 | n | — |
| 14 | n15 | n | — |
| 15 | g16 | n | — |
| 16 | | y | “3”, verb, present tense (i.e., cut 3 characters |
| | | | from the end of “talking” to get |
| | | | the lemma “talk”) |
| 17 | d18 | n | — |
| 18 | | y | “2”, verb, past tense (i.e., cut 2 characters |
| | | | from the end of “talked” to get |
| | | | the lemma “talk”) |

Now that we have identical glosses at the output states 7/9 and 16/18, it is possible to minimize the FST into the following:

| State | Transitions | Final | Gloss |
|---|---|---|---|
| 0 | w1, t1 | n | — |
| 1 | a2 | n | — |
| 2 | l3 | n | — |
| 3 | k4 | n | — |
| 4 | i5, e8 | n | — |
| 5 | n6 | n | — |
| 6 | g7 | n | — |
| 7 | | y | “3”, verb, present tense (i.e., cut 3 characters |
| | | | from the end of “talking” or “walking” to get |
| | | | the corresponding lemma “talk” or “walk”) |
| 8 | d9 | n | — |
| 9 | | y | “2”, verb, past tense (i.e., cut 2 characters |
| | | | from the end of “talked” or “walked” to get |
| | | | the corresponding lemma “talk” or “walk”) |

Unfortunately, this simple method cannot be applied, without adaptation, to the dictionaries proposed in the present invention wherein the case is explicitly represented. To understand the problem, consider the surface form “TALKING” which needs to be matched with the lemma “talk.” In the case where case variants are not explicitly represented in the dictionaries, it is possible to still use the cut and paste method for representing the lemma by using a rule that the lemma is constructed by cutting 3 characters from the end of the word that was matched in the dictionary, i.e., “talking,” rather than from the end of the word, i.e., “TALKING,” that was found in the text. Unfortunately, this method cannot be used when the case variation is explicitly represented in the dictionary, since the path “TALKING” will have been matched in the dictionary rather than the path “talking.”

This problem is overcome by extending the cut and paste algorithm by prefixing the gloss with a single byte gloss type code. The following special gloss type codes are therefore defined:

1=Do nothing;

2=Convert first character to upper case;

3=Convert first character to lower case;

4=Convert word to lower case;

5=Convert word to upper case;

6=Convert word to upper case and replace all single character sequences with equivalent double character sequences (e.g., replace β with SS and ö with oe); and

7=Convert word to lower case and replace all double character sequences with single characters (e.g., replace SS with β and OE with ö).

The type code is followed by a normal cut and paste gloss, i.e., <number of characters to cut> and <postfix to paste>.

In many cases this results in a relatively short cut and paste code. For example:

| | |
|---|---|
| Line from .OUT file: | TALKED, talk.<GLOSS> |
| Extended c&p code: | <Convert word to lower case><2><> |
| Length: | 2 bytes |
| Traditional c&p code: | 6talk |
| Old length: | 11 bytes for UTF-16 |
| Line from .OUT file: | Talked, talk.<GLOSS> |
| Extended c&p code: | <Convert first character to lower case><2><> |
| Length: | 2 bytes |
| Traditional c&p code: | 6talk |
| Old length: | 9 bytes for UTF-16 |
| Line from .OUT file: | talked, talk.<GLOSS> |
| Extended c&p code: | <Do nothing><2><> |
| Length: | 2 bytes |
| Traditional c&p code: | 2 |
| Old length: | 1 byte |

As can be seen from the examples above, the old cut & paste code is usually longer and, more importantly, it undermines minimization of the FST because (since cut & paste code contains copies of dictionary words) collapsing of state sequences will rarely be possible. Experience shows that the extended cut & paste method seems to be sufficient for practical usage. There is no significant increase in size of cut & paste information for Latin based writing systems. Although the need to do case conversion on the entire word would seem to negate much of the advantage of explicitly storing the various case variants in the dictionary, the gloss types that require case conversion of the entire word rarely occur. For most frequently occurring words, the code of conversion is either ‘DO NOTHING’ or ‘CONVERT FIRST LETTER’ since all-capital words typically only occur rarely (e.g., in titles). Thus, there is no significant performance impact.

The words containing multiple capital letters (e.g., “McDonalds”) are not handled by this approach properly, and an inefficient traditional cut & paste value must be used for these words (e.g., MCDONALDS, McDonalds, <GLOSS> gives a cut and paste value of <DO NOTHING>8cDonalds>). However, few of these words exist in the dictionary, and they do not influence the overall size of the resulting dictionary significantly.

Without the extended cut & paste variants, the dictionary could not be minimized effectively and hence the size would be prohibitive. However, when the extended cut & paste codes are used, the resulting dictionary with explicit representation of case variants can be minimized to slightly over twice the size of a dictionary without explicit representation of case variants. This is illustrated by the following simple example FSTs. In this simple example, the addition of explicit case variants causes the FST size dictionary to grow from dictionary 10 to dictionary 44 states with the traditional cut and paste, but it only grows to dictionary 19 states with the proposed extended cut & paste codes.

Explicit case representation with traditional cut & paste gives:

| State | Transitions | Final | Gloss |
|---|---|---|---|
| 0 | w1, t1, W10, T19 | n | — |
| 1 | a2 | n | — |
| 2 | l3 | n | — |
| 3 | k4 | n | — |
| 4 | i5, e8 | n | — |
| 5 | n6 | n | — |
| 6 | g7 | n | — |
| 7 | | y | “3”, verb, present tense (i.e., cut 3 characters from the end |
| | | | of “talking” or “walking” from dictionary to get the |
| | | | corresponding lemma “talk” or “walk”) |
| 8 | d9 | n | — |
| 9 | | y | “2”, verb, past tense (i.e., cut 2 characters from the end of |
| | | | “talked” or “walked” from dictionary to get the |
| | | | corresponding lemma “talk” or “walk”) |
| 10 | a11, A28 | n | — |
| 11 | l12 | n | — |
| 12 | k13 | n | — |
| 13 | i14, e17 | | |
| 14 | n15 | | |
| 15 | g16 | | |
| 16 | | y | “7walk”, verb, present tense (i.e., cut 7 characters from the |
| | | | end of “Walking” then add the characters “walk” from |
| | | | dictionary to get the lemma “walk”) |
| 17 | d18 | | |
| 18 | | y | “6walk”, verb, past tense (i.e., cut 6 characters from the end |
| | | | of “Walked” then add the characters “walk” from dictionary |
| | | | to get the lemma “walk”) |
| 19 | a20, A36 | n | — |
| 20 | l21 | n | — |
| 21 | k22 | n | — |
| 22 | i23, e26 | n | — |
| 23 | n24 | n | — |
| 24 | g25 | n | — |
| 25 | | y | “7talk”, verb, present tense (i.e., cut 7 characters from the |
| | | | end of “Talking” then add the characters “talk” from |
| | | | dictionary to get the lemma “talk”) |
| 26 | d27 | n | — |
| 27 | | y | “6talk”, verb, past tense (i.e., cut 6 characters from the end |
| | | | of “Talked” then add the characters “talk” from dictionary |
| | | | to get the lemma “talk”) |
| 28 | L29 | n | — |
| 29 | K30 | n | — |
| 30 | I31, E34 | n | — |
| 31 | N32 | n | — |
| 32 | G33 | n | — |
| 33 | | y | “7walk”, verb, present tense (i.e., cut 7 characters from the |
| | | | end of “WALKING” then add the characters “walk” from |
| | | | dictionary to get the lemma “walk”) |
| 34 | D35 | n | — |
| 35 | | y | “6walk”, verb, past tense (i.e., cut 6 characters from the |
| | | | end of “WALKED” then add the characters “walk” from |
| | | | dictionary to get the lemma “walk”) |
| 36 | L37 | n | — |
| 37 | K38 | n | — |
| 38 | I39, E42 | n | — |
| 39 | N40 | n | — |
| 40 | G41 | n | — |
| 41 | | y | “7talk”, verb, present tense (i.e., cut 7 characters from the |
| | | | end of “TALKING” then add the characters “talk” from |
| | | | dictionary to get the lemma “talk”) |
| 42 | D43 | n | — |
| 43 | | y | “6talk”, verb, past tense (i.e., cut 6 characters from the end |
| | | | of “TALKED” then add the characters “talk” from |
| | | | dictionary to get the lemma “talk”) |

Explicit case representation with extended cut & paste gives:

| State | Transitions | Final | Gloss |
|---|---|---|---|
| 0 | w1, t1, W10, T10 | n | — |
| 1 | a2 | n | — |
| 2 | l3 | n | — |
| 3 | k4 | n | — |
| 4 | i5, e8 | n | — |
| 5 | n6 | n | — |
| 6 | g7 | n | — |
| 7 | | y | “33”, verb, present tense (i.e., cut 3 characters from the end |
| | | | of “Walking”, “walking”, “Talking” or “talking” from |
| | | | dictionary to get “Walk”, “walk”, “Talk” or “talk” and then |
| | | | convert the first character dictionary lower-case dictionary |
| | | | to get the lemma “walk” or “talk”) |
| 8 | d9 | n | — |
| 9 | | y | “32”, verb, past tense (i.e., cut 2 characters from the end of |
| | | | “Walked”, “walked”, “Talked” or “talked” dictionary to get |
| | | | “Walk”, “walk”, “Talk” or “talk” and then convert the first |
| | | | character dictionary lower-case dictionary to get the lemma |
| | | | “walk” or “talk”) |
| 10 | a2, A11 | n | — |
| 11 | L12 | n | — |
| 12 | K13 | n | — |
| 13 | I14, E17 | | |
| 14 | N15 | | |
| 15 | G16 | | |
| 16 | | y | “43”, verb, present tense (i.e., cut 3 characters from the end |
| | | | of “WALKING”, or “TALKING” dictionary to get |
| | | | “WALK” or “TALK” and then convert the entire word |
| | | | dictionary lower-case dictionary to get the lemma “walk” or |
| | | | “talk”) |
| 17 | D18 | | |
| 18 | | y | “43”, verb, present tense (i.e., cut 3 characters from the end |
| | | | of “WALKED”, or “TALKED” dictionary to get “WALK” |
| | | | or “TALK” and then convert the entire word dictionary |
| | | | lower-case dictionary to get the lemma “walk” or “talk”) |

The new cut and paste rules allow for effective trade-offs to be made between dictionary size and speed of access. When the code is used that implies “convert all characters to lower case” a small dictionary can result. However, all of the benefits of explicit case representation are lost since there is a need to perform the case conversion anyway. Experiments have shown that the best performance figures are achieved by using the “convert first character” code in all cases except where a different code is explicitly needed (as in the example above).

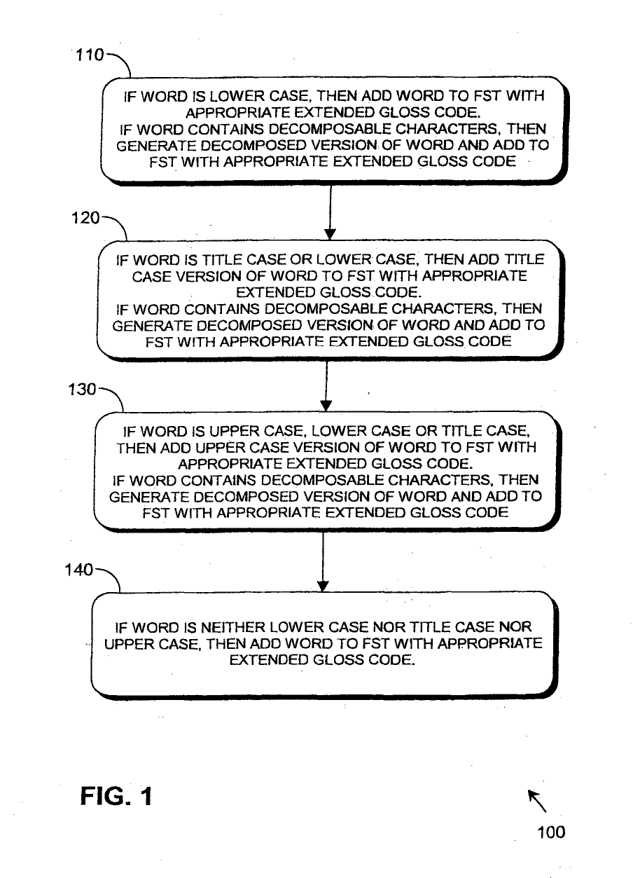

Referring now to FIG. 1, a method for producing a FST linguistic database is based on a sequence of instructions repeated for each dictionary word (dword) and associated lemma to be added to the dictionary:

Step 110:

If the dictionary word (i.e., dword) is lower case, then the lower case version of the word is added to the FST with an appropriate extended gloss code depending on whether the lemma is lower case. If the word contains decomposable characters, then a decomposed version of the word is generated and is added to the FST with an appropriate extended gloss code. This step may be represented by the following pseudo-code:

```
if (dword.is_lowercase( )) {
  if (lemma.is_lowercase( ))
    add dword to FST with extended gloss code convert_first_to_lowercase
  else
    add dword to FST with extended gloss code no_conversion
  if (dword contains decomposable characters){
    generate decword = dword with all precomposed characters replaced by decomposed
    add decword to FST with extended gloss code conv_to_lowercase_with_2_to_1
  }
}
```

This pseudo-code should be followed by the pseudo-code below in order to ensure processing of this word also occurs by the ‘if’ statement for step 120:

generate title_word with the first character in dword converted to uppercase set dword=title_word

Step 120:

If the dictionary word is title case or lowercase, then the title case version of the word is added to the FST with an appropriate extended gloss code depending on whether the lemma is lower case. If the word contains decomposable characters, then a decomposed version of the word is generated and is added to the FST with an appropriate extended gloss code depending on whether the lemma is lower case. This step may be represented by the following pseudo-code:

```
if (dword.is_titlecase( )) {
  if (lemma.is_lowercase( ))
    add dword to FST with extended gloss code convert_first_to_lowercase
  else
    add dword to dictionary with extended gloss code no_conversion
  if (dword contains decomposable characters) {
    generate decword = dword with all precomposed characters replaced by decomposed
    if (lemma.is_lowercase( ))
      add decword to FST with extended gloss code conv_to_lowercase_with_2_to_1
    else
      add dword to FST with extended gloss code no_conversion
  }
}
```

This pseudo-code should be followed by the pseudo-code below in order to ensure processing of this word also occurs by the ‘if’ statement for step 130:

generate upper_word with all of characters in dword converted to uppercase set dword=upper_word

Step 130:

If the dictionary word is upper case, lower case or title case, then the word is added to the FST with an appropriate extended gloss code depending on whether the lemma is lower case. If the word contains decomposable characters, then a decomposed version of the word is generated and is added to the FST with an appropriate extended gloss code. This step may be represented by the following pseudo-code:

```
if (dword.is_uppercase( )) {
  if (lemma.is_lowercase( ))
    add dword to FST with extended gloss code convert_all_to_lowercase
  else
    add dword to FST with extended gloss code no_conversion
  if (dword contains decomposable characters) {
    generate decword = dword with all precomposed characters replaced by decomposed
    add decword to FST with extended gloss code conv_to_lowercase_with_2_to_1
  }
}
```

Step 140:

If the dictionary word is neither lower case, nor title case nor upper case, then it must be mixed case, and if so, should be added to the FST with an appropriate extended gloss code. This step may be represented by the following pseudo-code:

else {
add dword to FST with extended gloss code no_conversion
}

Thus, the sequence of steps 110-140 may be represented by the combined pseudo-code of Appendix 1.

The performance benefit of this invention is significant for the Finite State Transducer dictionary considered because of the fact that it is already highly optimized. For example, experiments have shown that the throughput can be increased from 2.8 million characters per second to 4.1 million characters per second (an increase in throughput of approx 45%) by using the combination of explicit representation and extended cut & paste codes.

It will be appreciated that the method described above for producing a linguistic dictionary may be carried out in software running on a processor (not shown), and that the software may be provided as a computer program product carried on any suitable data carrier (also not shown) such as a magnetic or optical computer disc.

In conclusion, it will be understood that the technique described above for handling case and other orthographic variations in linguistic databases provides the advantage that it allows very efficient handling of case and orthographic variants while doing dictionary lookup.

Appendix 1: Pseudo-Code for Sequence of Steps of FIG. 1

```
For each dictionary word (i.e., dword) and associated lemma {
  if (dword.is_lowercase( )) {
    if (lemma.is_lowercase( ))
      add dword to FST with gloss code convert_first_to_lowercase
    else
      add dword to FST with gloss code no_conversion
    if (dword contains decomposable characters) {
      generate decword = dword with all precomposed characters replaced by decomposed
      add decword to FST with gloss code convert_to_lowercase_with_2_to_1
    }
    generate title_word with the first character in dword converted to uppercase
    set dword = title_word // forces processing of this word to enter next if statement
  }
  if (dword.is_titlecase( )) {
    if (lemma.is_lowercase( ))
      add dword to FST with gloss code convert_first_to_lowercase
    else
      add dword to dictionary with gloss code no_conversion
  if (dword contains decomposable characters) {
    generate decword = dword with all precomposed characters replaced by decomposed
    if (lemma.is_lowercase( ))
      add decword to FST with gloss code convert_to_lowercase_with_2_to_1
    else
      add dword to FST with gloss code no_conversion
  }
  generate upper_word with all of characters in dword converted to uppercase
  set dword = upper_word // forces processing of this word to enter next if statement
}
if (dword.is_uppercase( )) {
  if (lemma.is_lowercase( ))
    add dword to FST with gloss code convert_all_to_lowercase
  else
    add dword to FST with gloss code no_conversion
  if (dword contains decomposable characters) {
    generate decword = dword with all precomposed characters replaced by decomposed
    add decword to FST with gloss code convert_to_lowercase_with_2_to_1
  }
}
  else {
    // this must be a mixed-case word
    add dword to FST with gloss code no_conversion
  }
}
```

What is claimed is:

1. A method of producing a linguistic dictionary, the method comprising:
storing explicitly substantially all orthographic variations of words in a finite state transducer database, and
storing, for each of the orthographic variations, a cut and paste code extended by a gloss code that indicates whether at least part of the orthographic variation should be converted between upper and lower case.

2. The method of claim 1, wherein the gloss code further indicates whether conversion should be performed between each single and double character sequence in the orthographic variation.

3. The method of claim 1, wherein the gloss code indicates one of (i)-(vii):
(i) Do nothing;
(ii) Convert first character to upper case;
(iii) Convert first character to lower case;
(iv) Convert word to lower case;
(v) Convert word to upper case;
(vi) Convert word to upper case and replace each single character sequence with equivalent double character sequence; and
(vii) Convert word to lower case and replace each double character sequence with single characters.

4. The method of claim 1, further comprising:
storing, for each word having an accented character:
a word having a composite form of the accented character; and
a word having an expanded form of the accented character that includes a base character and an accent character.

5. A linguistic dictionary comprising:
a finite state transducer database for storing explicitly substantially all orthographic variations of words,
wherein the database further stores, for each of the orthographic variations, a cut and paste code extended by a gloss code that indicates whether at least part of the orthographic variation should be converted between upper and lower case.

6. The linguistic dictionary of claim 5, wherein the extended gloss code further indicates whether conversion should be performed between each single and double character sequence in the orthographic variation.

7. The linguistic dictionary of claim 5, wherein the extended gloss code indicates one of (i)-(vii):
(i) Do nothing;
(ii) Convert first character to upper case;
(iii) Convert first character to lower case;
(iv) Convert word to lower case;
(v) Convert word to upper case;
(vi) Convert word to upper case and replace each single character sequence with equivalent double character sequence; and
(vii) Convert word to lower case and replace each double character sequence with single characters.

8. The linguistic dictionary of claim 5, wherein the database stores, for each word having an accented character:
a word having a composite form of the accented character; and
a word having an expanded form of the accented character that includes a base character and an accent character.

9. A computer program product comprising computer program means for performing substantially the steps of:
storing explicitly substantially all orthographic variations of words in a finite state transducer database, and
storing, for each of the orthographic variations, a cut and paste code extended by a gloss code that indicates whether at least part of the orthographic variation should be converted between upper and lower case.

10. The computer program product of claim 9, wherein the extended gloss code further indicates whether conversion should be performed between each single and double character sequence in the orthographic variation.

11. The computer program product of claim 9, wherein the extended gloss code indicates one of (i)-(vii):
(i) Do nothing;
(ii) Convert first character to upper case;
(iii) Convert first character to lower case;
(iv) Convert word to lower case;
(v) Convert word to upper case;
(vi) Convert word to upper case and replace each single character sequence with equivalent double character sequence; and
(vii) Convert word to lower case and replace each double character sequence with single characters.

12. The computer program product of claim 9, further comprising computer program means for storing, for each word having an accented character:
a word having a composite form of the accented character; and
a word having an expanded form of the accented character that includes a base character and an accent character.
